(19) United States
(12) Patent Application Publication
(10) Pub. No.: US 2017/0117672 A1
(43) Pub. Date: Apr. 27, 2017

(54) VISOR ELECTRICAL CONNECTOR FOR END ITEM VISORS

(71) Applicant: FORD GLOBAL TECHNOLOGIES, LLC, Dearborn, MI (US)

(72) Inventors: Julian Lopacki, Holly, MI (US); David Huelke, Milan, MI (US); Eric Axel Smitterberg, Berkley, MI (US)

(21) Appl. No.: 14/921,266

(22) Filed: Oct. 23, 2015

(51) Int. Cl. H01R 13/73; B60J 3/02

(52) U.S. Cl. CPC H01R 13/73; B60J 3/026; H01R 2201/26

(57) ABSTRACT

A mounting assembly for a vehicle sun visor includes a headliner-mounted connector having a body carrying at least one connector electrical contact configured to be placed in electrical communication with a power source. A cooperating visor mounting member includes at least one cooperating visor electrical contact and a snap-fit retainer configured to engage the headliner-mounted connector and/or a portion of a headliner. In use, the connector and visor electrical contacts and snap-fit retainer are configured such that simply attaching the visor mounting member to the headliner-mounted connector and/or the portion of the headliner by way of the snap-fit retainer places the at least one connector electrical contact in electrical communication with the at least one visor electrical contact and completes an electrical circuit.

### TECHNICAL FIELD

This disclosure relates generally to sun visors for motor vehicles. More particularly, the disclosure relates to an improved sun visor mounting assembly including a connector configured for supplying electrical power to electronics associated with the visor blade.

### BACKGROUND

It is known to provide various electronics associated with sun visors for vehicles. For example, a sun visor blade may include such items as lighted vanity mirrors, clocks, compasses, entertainment devices such as DVD players for non-driver's side sun visors, GPS systems, and others. It is also known to provide sun visors with electrically-powered functions, such as visor blade extensions and the like. Such devices must be provided with a power source for operation.

With reference to FIG. 1, conventionally a visor assembly 100 includes a pivoting visor blade 102 and a pivot arm 104 about which the visor blade pivots (see arrows). Wiring 106 is typically passed through the pivot arm 104, ending in a pigtail or other terminal 108 configured for attaching to a headliner (not shown in this view) wiring harness 109 which supplies electrical power to the visor blade 102 electronics from a suitable power source 113, such as the vehicle battery. A bracket 110 allows securing the assembled visor assembly 100 to a portion of a vehicle roof such as a headliner (not shown), such as by fasteners 111.

With reference to FIG. 2, the pivot arm 104 and wiring 106 pass through an aperture in the bracket 110 which attaches the visor assembly 100 to a portion of a vehicle headliner 112, typically through an aperture 105 defined in the headliner. As is known, the headliner 112 in turn is secured to a vehicle passenger cabin roof panel 114. To attach the visor assembly 100 to the headliner 112, it is first necessary to connect the terminal 100 to a headliner wiring harness 109 (not shown in this view). Then, the mounting member 110 is attached to the headliner 112. This causes inconvenience in visor installation. Further, after the terminal 100 is connected to the headliner wiring harness 109, it is necessary to tuck the wiring into the headliner aperture. During this process, it is possible to damage the wiring. Thus, a need is identified in the art for improvements to connections for vehicle sun visors including wiring for supplying power to electronic accessories.

### SUMMARY

In accordance with the purposes and benefits described herein and to solve the above-summarized and other problems, in one aspect a mounting assembly for a vehicle sun visor is described, comprising a headliner-mounted connector comprising a body carrying at least one connector electrical contact configured to be placed in electrical communication with a power source. The assembly further comprises a visor mounting member comprising at least one cooperating visor electrical contact. The visor mounting member further includes a snap-fit retainer configured to engage the headliner-mounted connector and/or a portion of a headliner.

In embodiments, the assembly includes a pair of connector electrical contacts and a pair of cooperating visor electrical contacts. The assembly is configured whereby attaching the visor mounting member to the headliner-mounted connector and/or the portion of the headliner by way of the snap-fit retainer places the at least one connector electrical contact in electrical communication with the at least one visor electrical contact and completes an electrical circuit to transmit electrical power to one or more visor-associated electronics. As will be appreciated, this greatly simplifies the process of attaching a sun visor including electronic devices to a vehicle headliner, without requiring separately connecting visor wiring to a headliner wiring harness or the like.

The portion of the headliner may include a headliner aperture configured for receiving the visor mounting member. In embodiments, the headliner-mounted connector includes a connector aperture configured for at least partial concentric alignment with the headliner aperture. In embodiments, the connector aperture is configured for full concentric alignment with the headliner aperture.

In the following description, there are shown and described embodiments of the disclosed sun visor mounting assembly. As it should be realized, the assembly is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed sun visor mounting assembly, and together with the description serve to explain certain principles thereof. In the drawing:

FIG. 1 depicts a prior art wired sun visor and mounting bracket;

FIG. 2 depicts the sun visor of FIG. 1, attached to a vehicle headliner;

FIG. 3 depicts a bottom view of a headliner-mounted electrical connector for a sun visor according to the present disclosure;

FIG. 4 depicts a side view of the headliner-mounted electrical connector of FIG. 3;

FIG. 5 depicts a mounting member for a sun visor according to the present disclosure;

FIG. 6 depicts a sun visor mounting assembly according to the present disclosure, attached to a vehicle headliner; and

FIG. 7 shows a cross-sectional side view of an assembled headliner-mounted electrical connector and sun visor mounting member.

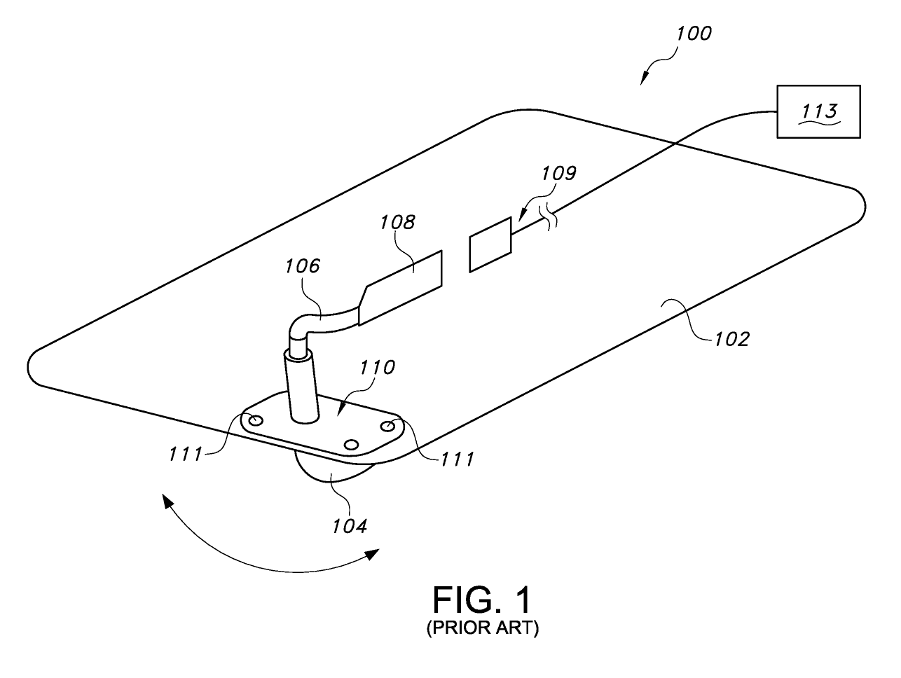

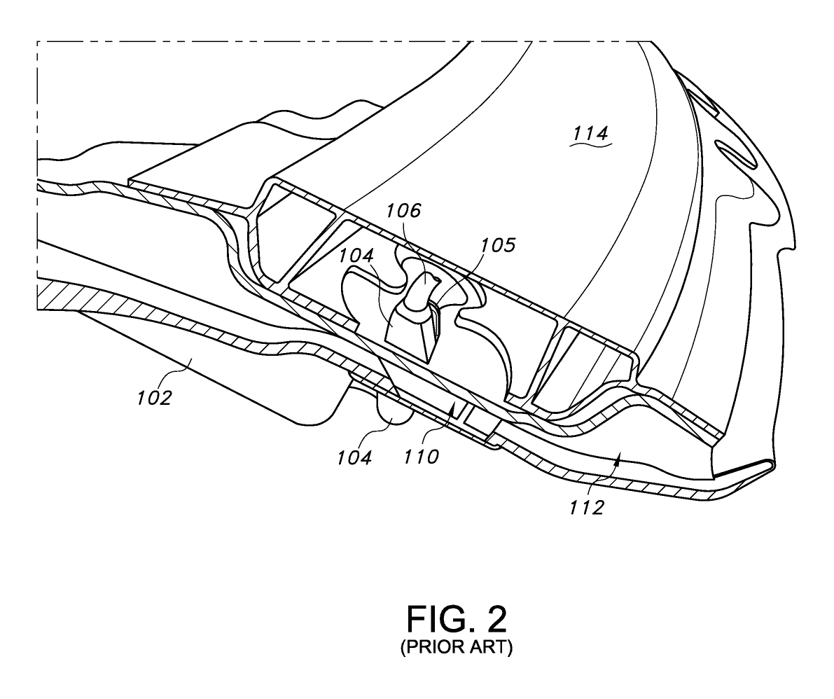

Reference will now be made in detail to embodiments of the disclosed sun visor mounting assembly, examples of which are illustrated in the accompanying drawing figures wherein like reference numerals indicate like features.

### DETAILED DESCRIPTION

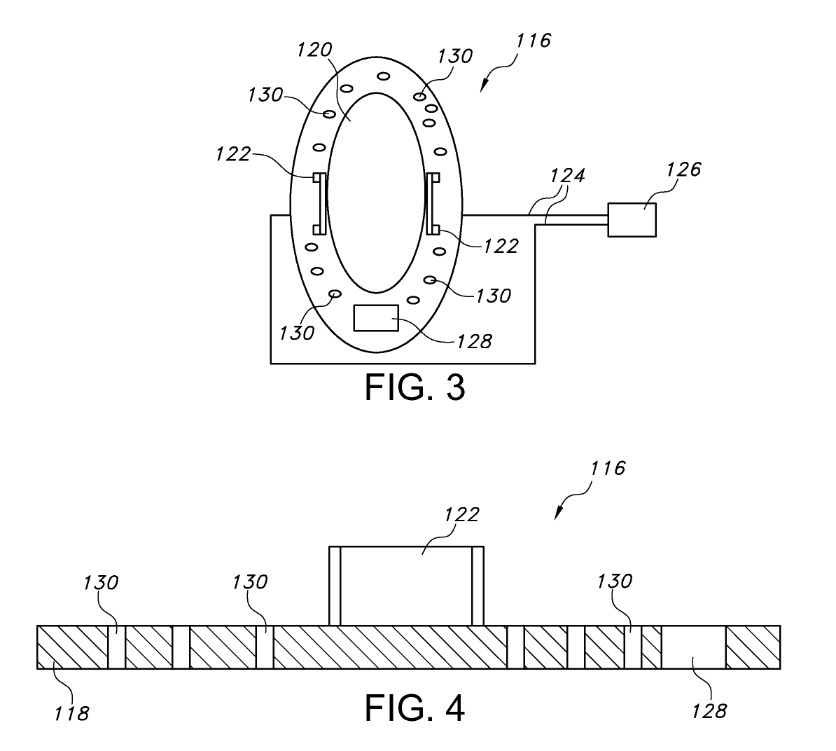

With reference to FIGS. 3 and 4, there is shown a headliner-mounted electrical connector 116. The headliner-mounted connector 116 includes a body 118 having a central aperture 120, the purpose of which will be described subsequently. The depicted embodiments of body 118 and aperture 120 are substantially ovoid in cross-sectional configuration. However, it will be appreciated that any suitable configuration finds utility for the present electrical connector 116, such as round, square, rectangular, hexagonal, and others. Any such cross-sectional configuration is contemplated for use herein.

The body 118 carries one or more headliner-mounted electrical connector electrical contacts 122. In the depicted embodiment, the body carries a pair of electrical contacts 122. However, it will be appreciated that more or fewer electrical contacts may be provided. Any suitable electrical contact is contemplated, including without intending any limitation plastic insertions into or extensions of the body 118, overlaid with a suitably electrically conductive material such as copper, snap-in electrical contacts, and others.

The one or more electrical contacts 122 are configured to be placed in electrical communication with a power source 113 (not shown in this view). In the depicted embodiment, this is accomplished by wiring 124 operatively connected to a suitable terminal 126. The terminal 126 is configured for connection to a cooperating mating terminal associated with wiring such as a headliner wiring harness 109 configured to be placed in electrical communication with a power source 113. Wiring 124 may be directly connected to the one or more electrical contacts 122. Alternatively, the headliner-mounted connector body 118 may be fabricated of a suitably conductive material, and the wiring 124 may be connected thereto. However, it will also be appreciated that alternative methods of placing the one or more electrical contacts 122 in electrical communication with a power source are known, and are contemplated for use herein. For example, wireless transmission of electrical power is known.

The headliner-mounted connector body 118 further includes a retention aperture 128, the purpose of which will be described below. Optionally, in embodiments the body 118 further includes one or more additional adhesive apertures or recesses 130, the purpose of which is to receive an adhesive used to mount the headliner-mounted connector 116 to a headliner surface (not shown in this view). As is known, such apertures or recesses 130 increase the surface area available for contact with an adhesive, thus increasing the strength of the adhesive bond.

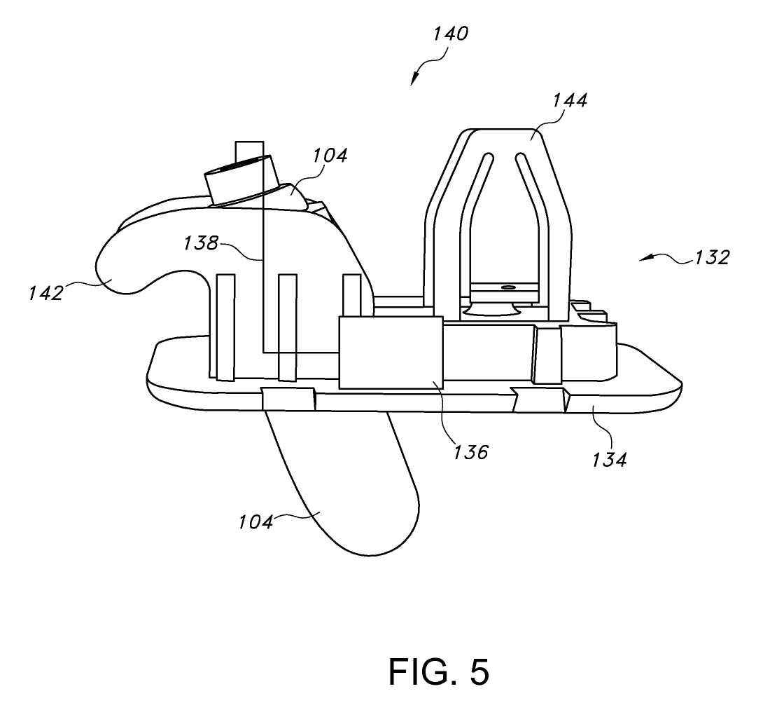

FIG. 5 depicts a visor mounting member 132 configured for operative interaction with the headliner-mounted electrical connector 116 described above. In the depicted embodiment, the mounting member 132 includes a base 134 carrying one or more visor electrical contacts 136. As will be described below, the one or more visor electrical contacts 136 are disposed whereby on attachment of the mounting member 132 to the headliner-mounted electrical connector 116, the one or more visor electrical contacts 136 are placed in contact with the one or more headliner-mounted electrical connector electrical contacts 122.

The one or more visor electrical contacts 136 are also configured for placing in electrical communication with one or more visor electronics (not shown). In the depicted embodiment, this is accomplished by wiring 138 connected at a first end to the one or more visor electrical contacts 136, and at a second end passing to an interior of a visor panel 102 (not shown in this view) such as by traversing through pivot arm 104. Again, alternative methods of placing devices in electrical communication with a power source are known, and are contemplated for use herein.

The visor mounting member 132 further includes a snap-fit retainer 140 configured for engaging the headliner-mounted connector body 118 and/or a portion of a headliner 114 (not shown in this view). In the depicted embodiment, the snap-fit retainer 140 includes at least one flange 142 and a retaining clip 144 mounted to the base 134. As will be appreciated, the snap-fit retainer flange 142 and retaining clip 144 are configured to engage the headliner-mounted connector body 118 by way of headliner body central aperture 120 and retention aperture 128. Thus, various configuration embodiments for the snap-fit retainer flange 142 and retaining clip 144 are contemplated in accordance with the various configurations provided for the headliner-mounted connector body 118 and/or central aperture 120 and/or retention aperture 128.

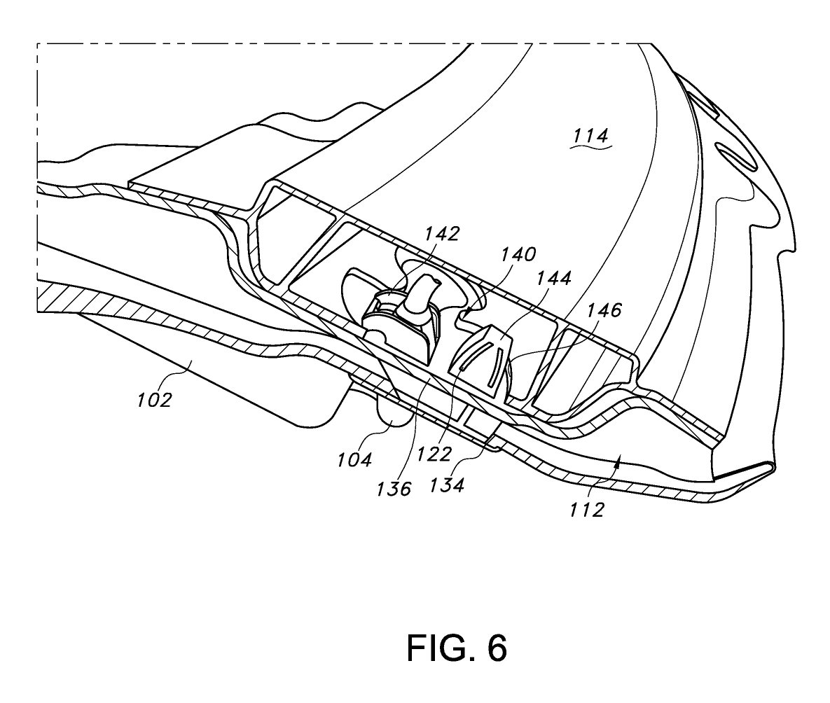

In greater detail, in use the headliner-mounted connector body 118 is secured to a portion of a headliner 112, such as by a suitable adhesive. Of course, alternative attachment methods are known and contemplated for use, such as welding, laser-welding, snap-fittings, and others. This is shown in FIG. 6. The headliner-mounted connector body 118 is attached to the headliner 112 whereby the body central aperture 120 is at least partially aligned with a corresponding headliner aperture 146. Typically, the body central aperture 120 and headliner aperture 146 are fully aligned. Flange 142 is caused to engage a portion of the connector body 118 and/or a portion of the headliner 112 interior surface. Then, retaining clip 144 is caused to engage the headliner-mounted connector body retention aperture 128.

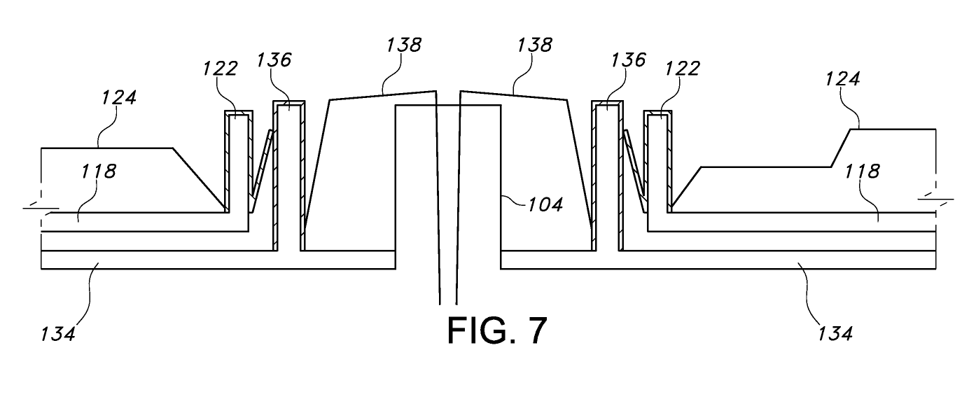

As summarized above, the headliner-mounted electrical connector electrical contacts 122 and visor electrical contacts 136 are respectively disposed on the electrical connector body 118 and the visor mounting member a base 134 whereby, when connected as described above, the headliner-mounted electrical connector electrical contacts 122 and visor electrical contacts 136 are automatically placed on contact with one another (see FIG. 7). Thus, on actuation of a suitable power source 113 (not shown in this view), an electrical circuit is completed and electrical power may be supplied to one or more visor 100-associated electronics (not shown in this view).

As will be appreciated, by the foregoing described features a simple, robust, and convenient mounting assembly for a sun visor 100 is provided, allowing easy placement of the sun visor 100 electronics into electrical communication with a vehicle power source 113. As will be appreciated and as described above, the visor 100 is simply snapped in place by way of the visor mounting member 132, and by that action an electrical circuit is completed. There is no need to first connect a vehicle headliner wiring harness before attaching the visor 100 to, e.g., a vehicle headliner 112. This improves ease of assembly such as during final vehicle assembly at a manufacturing plant, reducing labor costs and also reducing material costs and down time associated with having to replace damaged wiring and/or repair damage done to wiring during attachment of conventional powered sun visor assemblies.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. A mounting assembly for a vehicle sun visor, comprising:
a headliner-mounted connector comprising a body carrying at least one connector electrical contact configured to be placed in electrical communication with a power source; and
a visor mounting member comprising at least one cooperating visor electrical contact and a snap-fit retainer configured to engage the headliner-mounted connector and/or a portion of a headliner.

2. The assembly of claim 1, including a pair of connector electrical contacts.

3. The assembly of claim 2, including a pair of cooperating visor electrical contacts.

4. The assembly of claim 1, wherein attaching the visor mounting member to the headliner-mounted connector and/or the portion of the headliner by way of the snap-fit retainer places the at least one connector electrical contact in electrical communication with the at least one visor electrical contact and completes an electrical circuit.

5. The assembly of claim 1, wherein the portion of the headliner includes a headliner aperture configured for receiving the visor mounting member.

6. The assembly of claim 5, wherein the headliner-mounted connector includes a connector aperture configured for at least partial concentric alignment with the headliner aperture.

7. The assembly of claim 6, wherein the connector aperture is configured for full concentric alignment with the headliner aperture.

8. The assembly of claim 1, wherein the at least one cooperating visor electrical contact is configured to transmit electrical power to one or more visor-associated electronics.

9. A vehicle including the assembly of claim 1.

10. A mounting member for a vehicle sun visor, comprising a snap-fit retainer configured to engage a portion of a headliner and/or a headliner-mounted electrical connector and at least one visor electrical contact.

11. The mounting member of claim 10, wherein the at least one visor electrical contact is configured to transmit electrical power to one or more visor-associated electronics.

12. The mounting member of claim 11, including a pair of visor electrical contacts.

13. The mounting member of claim 11, wherein attaching the visor mounting member to the portion of the headliner and/or the headliner-mounted electrical connector by way of the snap-fit retainer places the at least one visor electrical contact in electrical communication with at least one cooperating headliner-mounted electrical connector electrical contact to complete an electrical circuit between the at least one visor electrical contact and a power source.

14. A sun visor including the mounting member of claim 10.

15. A headliner-mounted electrical connector for a vehicle sun visor, comprising a body carrying at least one electrical contact configured to be placed in electrical communication with a power source.

16. The electrical connector of claim 15, including a pair of electrical contacts.

17. The electrical connector of claim 15, wherein the body includes an aperture configured for at least partial concentric alignment with a cooperating headliner aperture.

18. The electrical connector of claim 17, wherein the body aperture is configured for full concentric alignment with the cooperating headliner aperture.

19. A vehicle headliner including the headliner-mounted electrical connector of claim 6.
